(19) United States
(12) Patent Application Publication
(10) Pub. No.: US 2019/0355027 A1
(43) Pub. Date: Nov. 21, 2019

(54) STREAMLINED WLAN CONNECTIVITY USING PRE-BOARDING DATA

(71) Applicant: July Systems LLC, Wilmington, DE (US)

(72) Inventors: Vivek S. MENON, Pleasanton, CA (US); Spandana Reddy TARIMELA, Castro Valley, CA (US); Rajesh T.S. REDDY, San Francisco, CA (US)

(21) Appl. No.: 16/413,053

(22) Filed: May 15, 2019

Related U.S. Application Data
(60) Provisional application No. 62/671,756, filed on May 15, 2018.

(51) Int. Cl. G06Q 30/02; H04L 12/24; G06Q 10/10; H04W 64/00; H04W 4/021

(52) U.S. Cl. CPC G06Q 30/0281; H04L 41/0806; H04W 4/021; H04W 64/003; G06Q 10/1095

(57) ABSTRACT

Techniques for facilitating WLAN onboarding are provided. User data is received, where the user data includes identifying information for at least a first user device. A device is detected within connection range of a wireless local area network (WLAN) system. It is determined, based on the user data, that the device is the first user device. A customized onboarding portal is generated for the first user device based on the user data, where the customized onboarding portal includes at least one element of the user data. The customized onboarding portal is then provided, to the first user device, where the customized onboarding portal enables a user of the first user device to connect to the WLAN system in a streamlined manner, relative to a non-customized onboarding portal.

### CROSS-REFERENCE TO RELATED APPLICATIONS

This application claims benefit of co-pending U.S. provisional patent application Ser. No. 62/671,756, filed May 15, 2018. The aforementioned related patent application is herein incorporated by reference in its entirety.

### TECHNICAL FIELD

Embodiments presented in this disclosure generally relate to WLAN systems and customer interaction technology. More specifically, embodiments disclosed herein relate to techniques for simplifying the WLAN onboarding process and personalizing the user's experience.

### BACKGROUND

Some existing systems allow users to use commercial entities' web sites to book an appointment onsite at one of the commercial entity's storefronts. In addition, some current systems enable users to log onto the commercial entities' onsite WLAN system (e.g., onsite WiFi) upon entering the WiFi range. When a user logs into onsite WiFi, user preferences and interests are usually not known and/or not gathered. Further, the onboarding process is manual and tedious, which causes many users to forgo utilizing the provided onsite WiFi.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a network deployment topology, according to one embodiment of the present disclosure.

FIGS. 2A, 2B and 2C illustrate a method for collecting and using pre-boarding login data, according to one embodiment of the present disclosure.

FIG. 3 illustrates a method for collecting pre-boarding login data using a web site plug-in, according to one embodiment of the present disclosure.

FIG. 4 illustrates a method for wireless network login using pre-boarding information, according to one embodiment of the present disclosure.

FIG. 5 illustrates a method for tracking a user's device through a space, according to one embodiment of the present disclosure.

FIG. 6 illustrates a method for triggering a smart A/V device to display a message customized to a user, according to one embodiment of the present disclosure.

FIG. 7 is a flow diagram illustrating a method for facilitating streamlined WLAN onboarding, according to one embodiment disclosed herein.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to one embodiment presented in this disclosure, a method is provided. The method includes receiving user data, wherein the user data includes identifying information for at least a first user device. The method further includes detecting a device within connection range of a wireless local area network (WLAN) system. It is determined, based on the user data, that the device is the first user device. The method then includes generating a customized onboarding portal for the first user device based on the user data, wherein the customized onboarding portal includes at least one element of the user data. Finally, the method includes providing, to the first user device, the customized onboarding portal, wherein the customized onboarding portal enables a user of the first user device to connect to the WLAN system in a streamlined manner, relative to a non-customized onboarding portal.

According to a second embodiment presented in this disclosure, a computer-readable storage medium is provided. The computer-readable storage medium has non-transitory computer-readable program code embodied therewith, the computer-readable program code executable by one or more computer processors to perform an operation. The operation includes receiving user data, wherein the user data includes identifying information for at least a first user device. The operation further includes detecting a device within connection range of a wireless local area network (WLAN) system. It is determined, based on the user data, that the device is the first user device. The operation then includes generating a customized onboarding portal for the first user device based on the user data, wherein the customized onboarding portal includes at least one element of the user data. Finally, the operation includes providing, to the first user device, the customized onboarding portal, wherein the customized onboarding portal enables a user of the first user device to connect to the WLAN system in a streamlined manner, relative to a non-customized onboarding portal.

According to a third embodiment presented in this disclosure, a system is provided. The system includes one or more computer processors, and a memory containing a program which, when executed by the one or more computer processors, performs an operation. The operation includes receiving user data, wherein the user data includes identifying information for at least a first user device. The operation further includes detecting a device within connection range of a wireless local area network (WLAN) system. It is determined, based on the user data, that the device is the first user device. The operation then includes generating a customized onboarding portal for the first user device based on the user data, wherein the customized onboarding portal includes at least one element of the user data. Finally, the operation includes providing, to the first user device, the customized onboarding portal, wherein the customized onboarding portal enables a user of the first user device to connect to the WLAN system in a streamlined manner, relative to a non-customized onboarding portal.

### Example Embodiments

Embodiments of the present disclosure allow for collection and transmission of user data (such as their name, IP address, preferences, and product interests) during a users' interaction with a commercial entity's web site or other digital asset such as a mobile application (e.g., while at home, or otherwise away from the storefront). In an embodiment, this collected information can be used to ease the WiFi on-boarding process when the user subsequently enters broadcast range of the commercial entity's WLAN system (e.g., WiFi network). Additionally, some embodiments of the present disclosure allow user data to be used in customizing the user's experience upon arrival at the storefront. Equipped with user data (such as the user's name, price range, product interests and the like), commercial entities are better-enabled to create a personalized, highly immersive experience for today's tech-savvy shoppers, and thus increase sales and strengthen customer loyalty.

In existing systems, onsite WiFi is often pitched by commercial entities to customers simply as a ‘free Internet connection,’ which a user may not find particularly valuable or enticing. This may especially be true if the user's mobile device service provider offers high-speed data connections to a user's mobile device (e.g., 4G, LTE, etc.), or the user is concerned about data privacy. Additionally, users may be relatively rushed or in a hurry, and may not want to bother signing into the WLAN system (especially if they do not plan to use their mobile device during the visit). Thus, in existing store locations, users frequently ignore invitations to connect to onsite WiFi upon arrival to a commercial entity storefront.

Furthermore, user trends suggest that there is an ever-increasing proportion of shoppers who research products on the Internet well before arriving at a commercial entity store front. Such tech-savvy users must often enter login data or other user information at the commercial entity web site, and again re-enter login data into the WiFi captive portal supplied by the commercial entity upon entering storefront WiFi range. From the users' point of view, these repetitive requests for information are redundant and can result in a frustrating experience. Indeed, this may cause users to feel distant when interfacing with the commercial entity, despite the possibility that they are frequent shoppers at that commercial entity. Embodiments of the present disclosure enable techniques to entice users to connect to commercial entities' WiFi. In some embodiments, this connection can be accomplished automatically, without user input. Further, embodiments of the present disclosure better leverage said WiFi to increase sales and improve customers' shopping experiences.

As used herein, the term “digital asset” refers to, by way of example and not limitation: web sites, mobile apps, video ad overlays, or any digital property that may be used to capture user-information. Further, as used herein, the term “pre-boarding” or “pre-onboarding” refers to capturing user details and/or storing user details in a WiFi subscriber system. In some embodiments, this pre-boarding process can be triggered before the actual onsite visit of the user. As described in the present disclosure, the term “check-in pass” refers to a digital file stored in a digital wallet app (e.g., Google Wallet™, Apple Wallet™) on a user's mobile device. In some embodiments, the check-in pass further stores a user's onsite appointment/reservation details (e.g., time, date, name of salesperson to meet with, etc.) along with the location of an onsite building.

As used herein, the term “WiFi check-in pass trigger” refers to the following mechanism: when a user with a mobile device associated with a check-in pass enter a commercial entity WiFi zone, one or more embodiments described herein trigger, prompting the mobile device to notify the user of a nearby WiFi network. In some embodiments, the notification occurs as a smart captive portal as described herein. Further, in some embodiments, the mobile device displays the check-in pass, thus encouraging a user to log in to the commercial entity WiFi and begin an appointment.

In the context of the present disclosure, “on-boarding” or “WiFi on-boarding” refers to the process of logging a user device onto a commercial entity WiFi system. “Pre-boarding” or “WiFi pre-boarding” refers to the process of logging a user device onto a commercial entity WiFi system using previously gathered user data. By way of example and not limitation, such user data can include user mobile device data, user login authorization, user demographics and any other user data. “Wireless signal,” “wireless signal transmitter” and “wireless device” may utilize any known wireless communications method, at any frequency, including but not limited to: WiFi (including e.g., 2.4 Ghz, 5.0 Ghz and 60 Ghz), cellular communications (including, e.g., 3G, 4G, LTE and the like) radio (e.g., frequencies common to AM and FM) and satellite communications methods (e.g., GPS and the like). Any examples of wireless communication or tracking methodologies used as described herein should be read as broadly as possible and not as limiting towards a specific type, frequency or encryption method of wireless signal. As used herein, “A/V device,” “smart A/V device,” and the like refers to a unit capable of audio transmission and/or video transmission, including but not limited to: smart televisions, speakers, computers, LED displays, WiFi-enabled displays, etc.

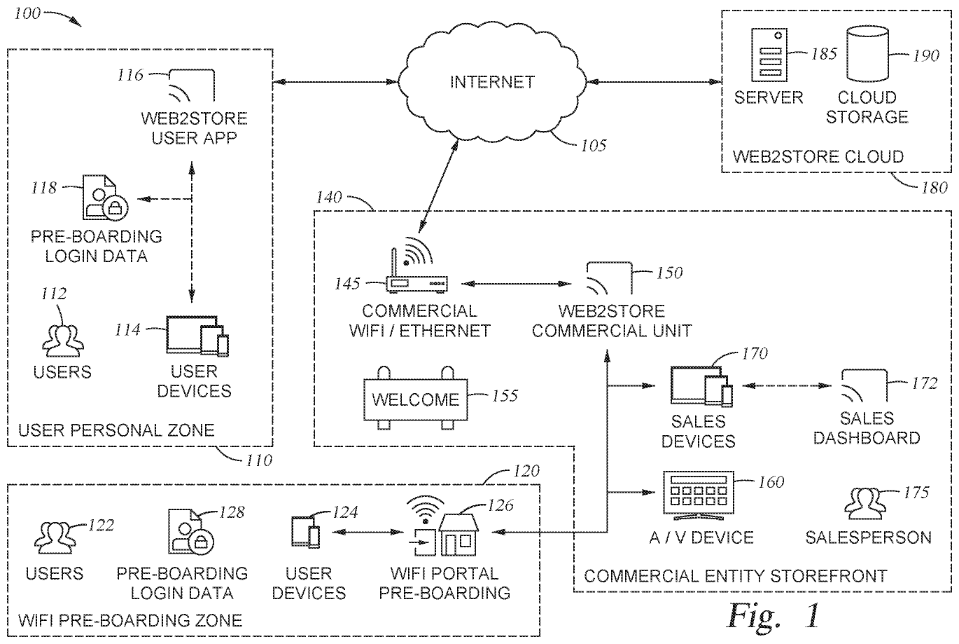

FIG. 1 illustrates a network deployment topology, according to one embodiment of the present disclosure. In the illustrated embodiment, the Network Topologies 100 include a User Personal Zone 110, a WiFi Pre-Boarding Zone 120, a Commercial Entity Storefront 140, and a Web2Store Cloud 180. In the illustrated embodiment, the User Personal Zone 110 includes a User 112, one or more User Devices 114, and a Web2Store App 116. In one embodiment, the User Personal Zone 110 represents any area in which a user can browse the internet, and may be, for example, a home of the user, a coffee shop the user is sitting in, and the like. Generally, the User Personal Zone 110 can be any location where a User 112 can use the Web2Store App 116 on User Device(s) 114. In embodiments, the User Devices 114 can be for example, a laptop, a desktop, a mobile device, a tablet, an Internet browser, and the like.

In embodiments, Users 112 can browse a commercial entity's web site (or other web sites) and research the commercial entity's products offered for sale. In one embodiment, the Web2Store User App 116 is part of the commercial entity's webpage (e.g., as a plug-in, widget and the like). In some embodiments, the Web2Store User App 116 can collect user data, such as the user's name (and/or username), location, demographics, preferences, products in which the user is interested, and any other information that may be gathered about a user. In some embodiments, the system can determine that a User 112 plans to visit a storefront location of the commercial entity. In one embodiment, this determination is made when a User 112 indicates their intent directly, such as by booking an appointment. In another embodiment, the system can determine (independently of any indication from the User 112) that the User 112 intends to make a visit. In one embodiment, for example, the system analyzes the User's 112 online behavior, and supplies this data to an analytics engine (not shown).

In any case, embodiments described herein can make a determination that User 112 intends to visit a storefront location, and thus prompt or otherwise collect additional user information in the form of pre-boarding user login information. This additional user information can be, in one embodiment, data that can enable WiFi pre-boarding when the User 112 visits a storefront location and enters the WiFi Pre-Boarding Zone 120. In the illustrated embodiment, the WiFi Pre-Boarding Zone 120 includes Users 122, User Devices 124, a WiFi Pre-boarding Portal 126, and Pre-Boarding Login Data 128. In some embodiments, a User 122 is the User 112 who, after visiting a commercial entity's web site, decided to visit commercial entity storefront 140.

In some embodiments, as the User(s) 122 approach the Commercial Entity Storefront 140, the User 122 first enters the WiFi Pre-Boarding Zone 120. In one embodiment, the WiFi Pre-Boarding Zone 120 represents the extent or range of a commercial entity's WiFi broadcast zone (e.g., the physical area within which the User Devices 124 are able to connect to the entity's WiFi network). In one embodiment, a User Device 124, which belongs to or is associated with a User 122, receives a WiFi broadcast signal from the Commercial WiFi 145. In an embodiment, after receiving this signal, the WiFi Pre-Boarding Portal 126 appears on the User Device 124.

In one embodiment, the WiFi Pre-Boarding Portal 126 takes the form of a WiFi captive portal customized with pre-boarding user login information. In one embodiment, the user is identified based on the detected User Device 124. For example, in one embodiment, when the user data is collected, the system stores an identity of the device providing the data. If that same device is subsequently detected at the WiFi Pre-Boarding Zone 120, the WiFi Pre-Boarding Portal 126 can be customized with the corresponding user information. In another embodiment, the user can specify or identify the device(s) they will be carrying when they visit the storefront. In such an embodiment, when this User Device(s) 124 is detected, the system can identify the associated user, retrieve the corresponding user data, and use it to facilitate the onboarding process.

In some embodiments, the WiFi Pre-Boarding Portal 126 entices the User 122 to connect to Commercial WiFi/Ethernet 145, such as by offering to confirm a previously-booked appointment. In one embodiment, the WiFi Pre-Boarding Portal 126 entices the User 122 to connect by using personalized information in order to generate personalized data or offers, such as discounts on items that the User 122 displayed interest in when the User 122 was browsing the commercial entity's web site prior to their visit.

In various embodiments, the system can take a number of steps or actions to pique the user's interest, and entice a user to join the Commercial WiFi/Ethernet 145. For example, in one embodiment, the system can prompt the user to log into commercial WiFi/Ethernet 145 using a check-in pass, discussed in more detail below. In some embodiments, the system reduces the number of steps involved in WiFi on-boarding by opting for a single identifier based process. In another embodiment, the system provides a clear reason to entice the user to connect to the Commercial WiFi/Ethernet 145, such as by making said connection necessary in order to complete a previously booked appointment or engagement.

In some embodiments, the WiFi Pre-Boarding Portal 126 simplifies and streamlines the traditional WiFi login by using the Pre-Boarding Login Data 128 to reduce the number of manual steps, the amount of information required to be manually entered, and the like. In embodiments, the Pre-boarding Login Data 128 can include Pre-Boarding Login Data 118, which was collected or provided previously during the browsing session in the User Personal Zone 110. In some embodiments, the Pre-Boarding Login Data 128 and/or Pre-Boarding Login Data 118 includes data such as pre-authorization to connect to the Commercial WiFi/Ethernet 145, thus allowing the User Device 124 to connect immediately and automatically to the Commercial WiFi/Ethernet 145, with or without the user's explicit onsite permission (because said permission was gathered beforehand as part of the Pre-Boarding Login Data 118). In another embodiment, the WiFi Pre-Boarding Portal 126 appears, rather than an automatic and/or instant connection, in order to accommodate for user privacy concerns.

In one embodiment, the arrival of the User 122 can be transmitted to the Web2Store Cloud 180 and/or employees of the commercial entity (e.g., a Salesperson 175). In an embodiment, the border of the WiFi-Pre-Boarding Zone 120 represents an effective transmission range of the onsite WiFi, which the physical perimeter of the storefront may or may not intersect. In another embodiment, the WiFi Pre-Boarding Zone 120 represents a threshold for the commercial entity's WiFi signal strength, which, when met, allows User Devices 124 to begin transmitting data through the Commercial WiFi 145.

In the illustrated embodiment, the Commercial Entity Storefront 140 includes the Commercial WiFi/Ethernet 145, a Web2Store Commercial Unit 150, Signage 155, A/V Device(s) 160, one or more Sales Devices 170, and at least one Salesperson 175. In embodiments, the Commercial WiFi/Ethernet 145 can correspond to a WiFi transponder/access point, and/or an ethernet switch, as known in the art. In an embodiment, the Web2Store Commercial Unit 150 is a representation of the commercial-facing side of embodiments described herein, and transmits/receives data to and from the Web2Store Cloud 180. In some embodiments, the Web2Store Commercial Unit 150 is an onsite server (not shown) located proximate (e.g., on or near) to the Commercial Entity Storefront 140. In other embodiments, the Web2Store Commercial Unit 150 is an app loaded onto one or more Sales Devices 170. In still other embodiments, the Web2Store Commercial Unit 150 can be omitted, and computing elements (e.g., Sales Devices 170 and/or smart A/V Devices 160) can transmit data directly to and from the Web2Store Cloud 180. Any and all methods of transmitting, processing and storing customer/sales data are included in embodiments of the present disclosure.

In embodiments, the Signage 155 and/or A/V Devices 160 can be used to inform the User 122. In one embodiment, the Signage 155 is directed towards visitors who have either scheduled a visit in advance, and/or at walk-in visitors, in order to entice visitors to connect to the Commercial WiFi/Ethernet 145. In embodiments, the Signage 155 may take the form of, for example, floor stickers, easel-based signs, wall signs, electronic signs, or any known signage. In an embodiment, a Salesperson 175, equipped with one or more Sales Devices 170, is an employee of the entity that owns and/or operates the Commercial Entity Storefront 140. The Sales Device 170 can employ or display a Sales Dashboard 172. In one embodiment, the Sales Dashboard 172 displays the status of one or more Users 122 that have logged into the Commercial WiFi/Ethernet 145, and/or Users 122 that have entered the Commercial Entity Storefront 140 (even without logging in). In one embodiment, the Sales Dashboard 172 notifies one or more Salespeople 175 of User 122 activity.

In one embodiment, while connecting to the Commercial WiFi/Ethernet 145 (or after connecting), the User 122 enters the Commercial Entity Storefront 140, and can meander about the commercial entity's property, viewing products and/or encountering Signage 155, A/V Devices 160, and/or employees. In one embodiment, the Signage 155 encourages the Users 122 to connect to the Commercial WiFi/Ethernet 145 through the WiFi Pre-Boarding Portal 126 (e.g., if the User 122 has not already done so). In one embodiment, the Signage 155 directs Users 122 towards specific location(s) within the Commercial Entity Storefront 140, where the User 122 can be assisted by a Salesperson 175.

In some embodiments, the User 122 may encounter A/V Device(s) 160 when entering the area. In one embodiment, one or more A/V Devices 160 can display a welcome screen tailored to the particular User 122. For example, this welcome screen may include user data such as their name, appointment time, products of interest, and/or information about the Salesperson 175 they will meet with. In one embodiment, the A/V Device 160 triggers this welcome screen when directed to by the Web2Store Commercial Unit 150. In embodiments, the Web2Store Commercial Unit 150 determines the location of the Users 122 through tracking means such as WiFi positioning. That is, in one embodiment, the Web2Store Commercial Unit 150 determines the location of each User Device 124 connected to the Commercial WiFi/Ethernet 145, and thereby infers the location of each User 122 associated with one or more of these User Devices 124.

In one embodiment, the A/V Device(s) 160 indicate to the User 122 to wait in a specified area for handling by a Salesperson 175. In some embodiments, the Sales Device 170 can receive a notification from the Web2Store Commercial Unit 150. In one embodiment, this notification indicates various data to the Salesperson 175, such as that a particular User 122 is waiting for assistance in a lobby area of the Commercial Entity Storefront 140. In some embodiments, this notification can also indicate user data, such as user demographics, the user's name, and products the user is interested in learning more about or purchasing.

Thus, embodiments of the present disclosure enable the Salesperson 175 to perform a “warm sales call,” using the user data that is available on the Sales Device 170. This custom and informed approach to the User 122 is in stark contrast to the uninformed (“cold”) sales calls that salespersons are often forced to conduct, due to lack of customer knowledge. In this manner, the User 122 experiences a more personalized, enjoyable, and immersive shopping experience, as opposed to the uncomfortable “hard sell” that occurs in storefronts (e.g., car dealerships) utilizing existing technologies.

In the illustrated embodiment, the Web2Store Cloud 180 contains a Server 185, and Cloud Storage 190. In an embodiment, the Server 185 exchanges data across Internet 105 with one or more of the other illustrated elements, such as the Web2Store Commercial Unit 150, the Web2Store User App 116, and the like. In one embodiment, the Server 185 stores collected data in the Cloud Storage 190. The environment depicted in FIG. 1 provides many different embodiments for implementing different features of the present disclosure. Specific embodiments of components and processes are described to help clarify the disclosure. These are, of course, merely embodiments and are not intended to limit the present disclosure. For example, in one embodiment, the functionality and operations of the system (e.g., gathering user data, determining that the user will visit the storefront, storing the user data, determining that the user has entered WLAN range, and initiating the user onboarding) can be combined or divided across any number of devices, including cloud applications, local devices at the storefront, and the like.

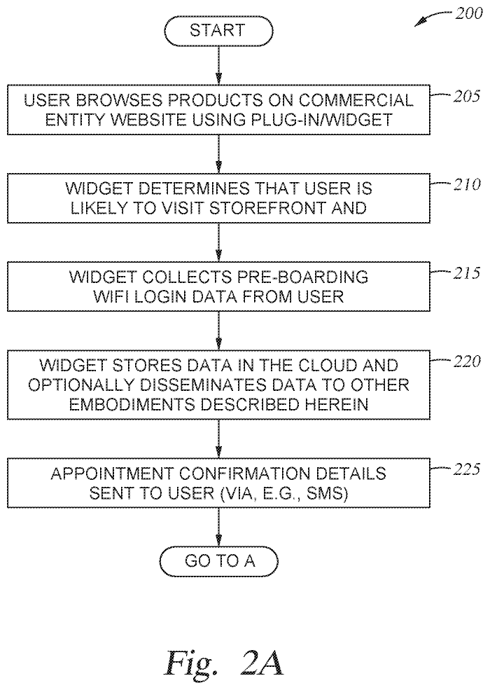

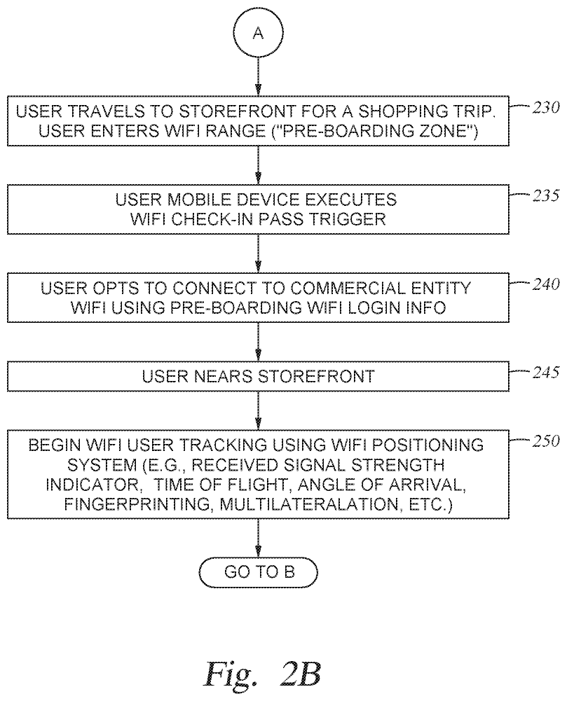

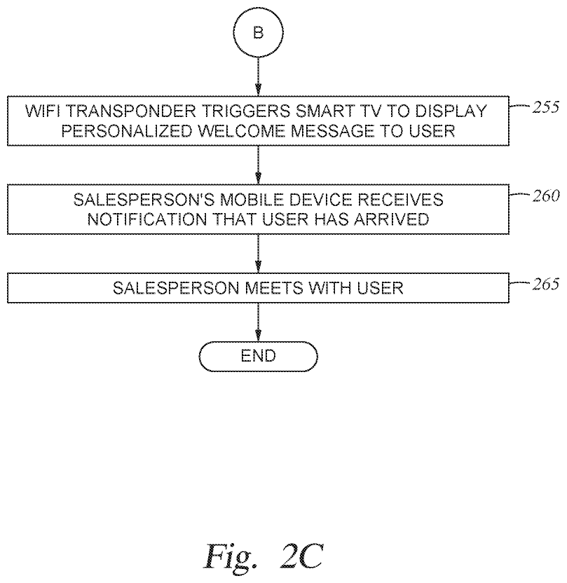

FIGS. 2A, 2B and 2C illustrate a method for WiFi pre-boarding, according to one embodiment of the present disclosure. Although the method steps are described in conjunction with FIGS. 1-6, persons skilled in the art will understand that any system configured to perform the method steps, even in a different order, can fall within the scope of the present disclosure. Moreover, the steps in this method are illustrative only and do not necessarily need to be performed in the given order they are presented herein. In some embodiments, certain steps may be omitted completely.

The method 200 begins at block 205, where a user opens a browser to visit a commercial entity web site (e.g., a car dealership's web site) and browses products. In one embodiment, the browser may include a plug-in or widget including one or more elements of the embodiments described herein. By way of example and not limitation, such a widget can be the Web2Store User App 116. The method 200 then proceeds to block 210, where the widget (e.g., the Web2Store User App 116) determines that the user is going to (or is likely to) visit a storefront. In some embodiments, this determination is based on the user's browsing behavior. For example, in one embodiment, the browsing history can indicate that the user has booked or is booking an appointment at the storefront. In another embodiment, embodiments described may determine (independently of any direct input from the user) that the user intends to make a visit by, for example, analyzing the user's online behavior and supplying said data to an analytics engine.

The method 200 then proceeds to block 215, where the system prompts the user for information, or otherwise collect additional user information to be used as pre-boarding user login information. Pre-boarding user login information is, in one embodiment, data that can enable WiFi onboarding when the user visits the storefront location and enters a WiFi pre-boarding zone. In various embodiments, the pre-boarding user login information can include (but is not limited to): the user's full name, phone number, email address, purpose of visiting the onsite area, and any preferences of the user, such as favorite product, a preferred time of visit, a budget, and the like. In one embodiment, this collection process occurs when the user is interacting with the commercial entity's digital asset (e.g., web site).

In another embodiment, the collection process can be triggered by one or more events or actions of the user, such as expressing interest for an onsite demo of a product, a request to purchase a product online for pick up in store, a request to set up a personal shopper consultation, an RSVP for an in-store event, a sign-up for personalized onsite services, signing up for an onsite loyalty program, a sign-up for product updates and local store information, and the like.

Once this information is collected, the method 200 proceeds to block 220, where the pre-boarding user login information is transmitted to the cloud storage system, described above. Finally, at block 255, appointment confirmation details (if available/applicable) are sent to the user (e.g., via SMS). In some embodiments, this confirmation can arrive in the form of a WiFi check-in pass. In an embodiment, this check-in pass can be stored in a digital wallet app (e.g., Google Wallet, Apple Wallet) on the user's mobile device. Further, in an embodiment, the check-in pass stores the user's onsite appointment/reservation details (e.g., time, date, name of salesperson to meet with, etc.) along with the location of the appointment (e.g., the particular storefront and/or a particular location at the store).

Turning to FIG. 2B, at block 230, the user travels to the storefront associated with the commercial entity, and brings one or more wireless devices. Specifically, the user enters the wireless signal pre-boarding zone. In one embodiment, the wireless signal pre-boarding zone is equipped with a wireless signal transponder. In an embodiment, the wireless signal transponder is part of a commercial entity's storefront WiFi. In some embodiments, the wireless signal pre-boarding zone represents a WiFi-enabled zone where WiFi supplied by the commercial entity storefront reaches a user's mobile device. While WiFi is given as an example, any and all wireless communication methods and frequencies can be utilized in a given implementation.

The method 200 then proceeds to block 235, where the user's wireless device receives a handshake from the wireless signal transponder, and prompts the user to connect to the wireless signal transponder. In one embodiment, this prompt takes the form of a WiFi captive portal that is customized with pre-boarding user login information. Additionally, in one embodiment, the WiFi pre-boarding portal entices the user to connect to commercial WiFi/ethernet by, for example, offering to confirm a previously booked appointment. In another embodiment, a WiFi check-in pass trigger occurs. In such an embodiment, the WiFi check-in pass trigger occurs when the user with a check-in pass (associated with the mobile device) enters a commercial entity WiFi zone. In some embodiments, the system can trigger, prompting the mobile device to notify the user of a nearby WiFi network. In some embodiments, the notification occurs as a smart captive portal, as described herein. Further, in some embodiments, the mobile device displays the check-in pass, thereby encouraging the user to log in to the commercial entity WiFi and begin the appointment.

In some embodiments, the trigger occurs based on proximity of the mobile device to the commercial entity WiFi network. In one embodiment, when the mobile device is in range of the commercial entity WiFi network, the digital wallet app triggers the WiFi check-in pass to appear as a notification on the mobile device. In some embodiments, the onsite brand messaging related to WiFi connectivity is consistently managed across digital assets and onsite display banners. In one embodiment, the WiFi pre-boarding portal entices the user to connect the wireless signal by using personalized information collected as pre-boarding login information. For example, in one embodiment, this personalized information can include discounts on, or information about, products that the user displayed interest in when the user was browsing the commercial entity's web site prior to the visit (e.g., by searching for it, spending some amount of time looking at it, and the like).

As another example, the WiFi captive portal page can display customer information in order to provide a personalized, immersive shopping experience. Any and all forms of enticement are contemplated in embodiments of the present disclosure. In one embodiment, the prompt sent to the user's device takes the form of a digital wallet data file or check-in pass as described herein. This digital wallet software on the user's mobile device(s) can operate using the location of the mobile device (e.g., as determined via GPS), and the digital wallet software can trigger the check-in pass based on proximity to the physical location associated with the check-in pass (e.g., the storefront). The method 200 then continues to block 240.

In the illustrated embodiment, at block 240, the user can opt to connect to the wireless signal transponder. In some embodiment, this opt-in was completed previously (e.g., while the user was at home), such that the user device can automatically connect to the WiFI system. In one embodiment, this connection is facilitated by the pre-boarding user login information. In an embodiment, this connection is enabled by one or more identifiers, including but not limited to: email address, phone number, one or more names, any user information as described herein, and the like. In some embodiments, providing this information informs enterprise systems as to the user's arrival, thus simplifying and speeding the WiFi on-boarding process and improving the customer experience.

Customer WiFi experience has been shown to be directly linked to customer satisfaction scores (CSATs), and thus embodiments of the present disclosure can improve CSAT scores for commercial enterprises that employ embodiments described herein. In some embodiments, step 240 can be omitted if the user is a repeat customer and has connected to the commercial entity WiFi in the past, or has previously provided physical identifiers in the past. The method 200 then proceeds to block 245, where the user travels into the commercial entity storefront. Again, note that the commercial entity storefront border can represent an effective transmission range of the onsite WiFi, and this border may or may not intersect with the physical perimeter of the storefront in reality. In an embodiment, this layout can be determined as needed by commercial entities. At this point the user may encounter signage (e.g., indicating a direction or location to travel to, or encouraging the user to login to the commercial entity WiFi if the user has not already done so.

In the illustrated embodiment, at block 250, the wireless signal transponder tracks the position of the wireless device (e.g., using received signal strength indicators, time of flight, angle of arrival, fingerprinting, and the like. Continuing to FIG. 2C, at block 255, embodiments described herein can trigger one or more smart A/V devices (e.g., a WiFi-enabled TV) to display customized messages. In one embodiment, this customized message is a personalized welcome message targeted to the user when the user comes with a predetermined distance of the smart A/V device. The smart A/V device can use user data as described herein to personalize the welcome message. In one embodiment, A/V device may indicate to the user to wait in a specified area for handling by salesperson.

The method 200 then continues to block 260, where one or more sales devices receive one or more notifications indicating user data to salesperson. For example, in one embodiment, the information can indicate that the user is waiting for assistance in a lobby area of the storefront. This notification may also indicate user data as described herein, such as the user name, demographics, and products the user is interested in learning more about. At block 265, a salesperson can thus meet with the user in the area specified (e.g., as indicated on the sales device), and engage in a “warm sales call.” The method 200 then terminates.

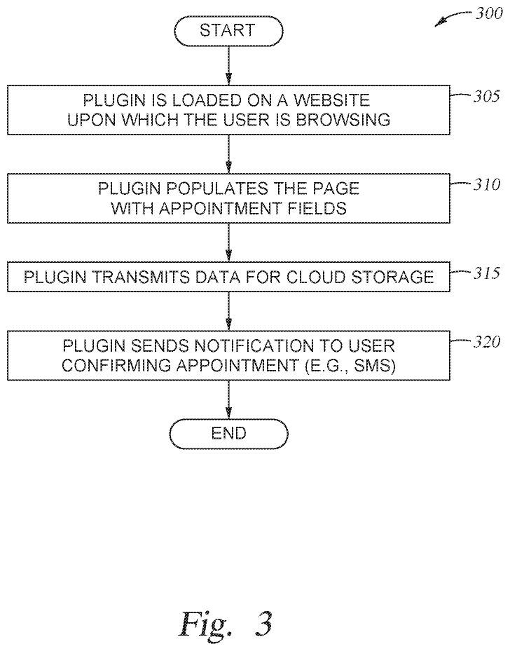

FIG. 3 illustrates a method for collecting pre-boarding login data using a web site plug-in, according to one embodiment of the present disclosure. The method 300 begins at block 305, where a plugin is loaded on a web site that a user is browsing or can browse. The method 300 continues to block 310, where the plugin populates the page with appointment fields. For example, in one embodiment, these fields can include name, date of appointment, time of appointment, chosen storefront, etc. At block 315, this data is transmitted to one or more components described herein, such as the cloud storage. The method 300 then continues to block 320, where the plugin sends a notification to the user (e.g., as an SMS, but all known forms of notifications are contemplated). In one embodiment, the notification informs the user that their appointment is confirmed.

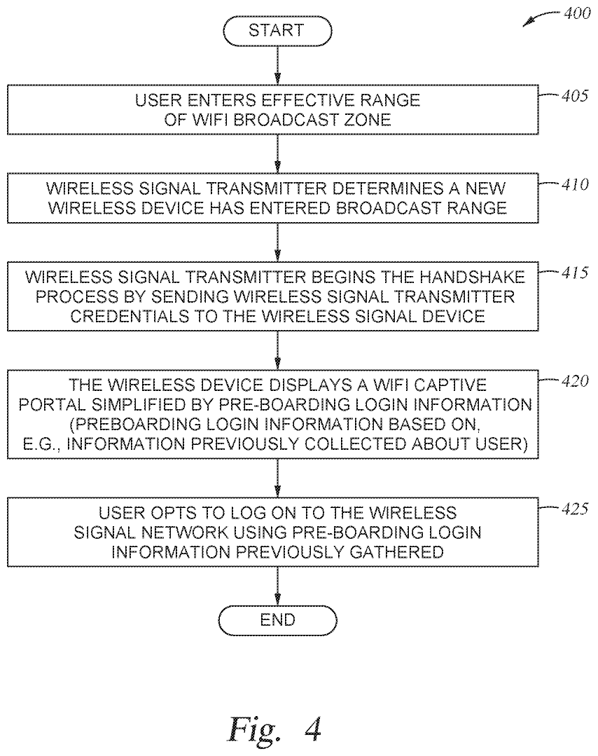

FIG. 4 illustrates a method for wireless network login using pre-boarding information, according to one embodiment of the present disclosure. The method 400 begins at block 405, where a user enters the effective broadcast range of a wireless signal transmitter. In one embodiment, the wireless signal transmitter is one or more WiFi transmitters or access points capable of covering a storefront such as a car dealership or shopping mall. At block 410, the wireless signal transmitter determines that a new wireless device has entered broadcast range, and may be made part of the wireless signal network. In one embodiment, this wireless device is a user's mobile device (e.g., a smartphone or tablet). The method 400 then continues to block 415, where the wireless signal transmitter begins the handshake process by sending wireless signal transmitter credentials to the wireless signal device. In one embodiment, these credentials can include, for example, an IP address, a WiFi captive portal page, and the like.

The method 400 proceeds to block 420, where the wireless device notifies the user of the available connection (e.g., using the wireless signal transmitter credentials). In one embodiment, this notification occurs in the form of a WiFi captive portal page. In such an embodiment, the WiFi captive portal page can be simplified using pre-boarding login information for the user. In one embodiment, this WiFi captive portal page can further be personalized to the user. For example, in one embodiment, the WiFi captive portal page can indicate additional user data such as a previously scheduled appointment time, products the user has previously indicated interest in, a sales appointment location (e.g., lobby), and/or the user's personal information. In the illustrated embodiment, the method 400 then continues to block 425, where the user opts to log on to the wireless signal network. In the illustrated embodiment, this log on process is simplified using pre-boarding login information (e.g., previous authorization, stored user credentials, and the like).

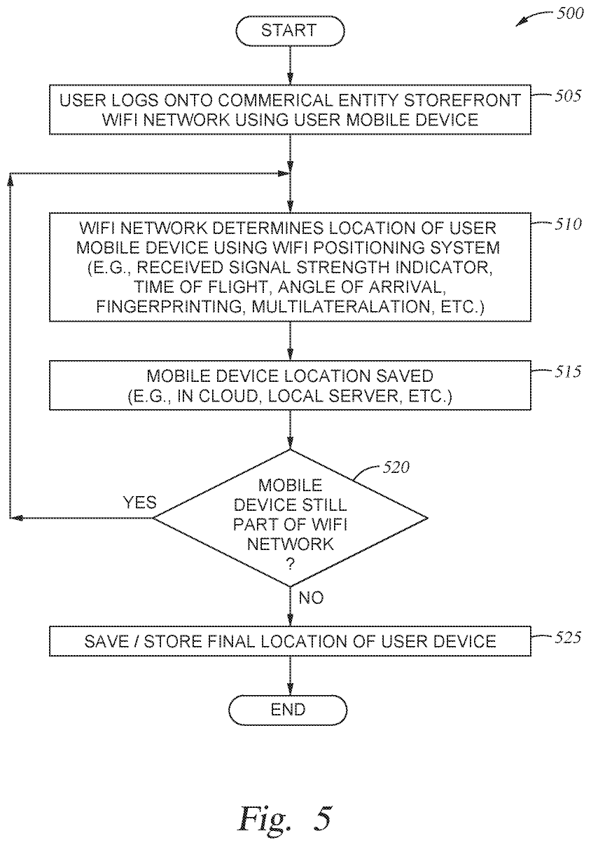

FIG. 5 illustrates a method for a method for tracking a user's device through a physical space, according to one embodiment of the present disclosure. The method 500 begins at block 505, where a user logs onto a network using a wireless device. In one embodiment, the network and device are WiFi-enabled. In an embodiment, the network is part of a commercial entity storefront, as described herein. Additionally, in an embodiment, the wireless device is a user's mobile device. At block 510, at least one wireless signal transponder currently transmitting to the wireless signal transmitter determines the current location of the wireless device within the wireless signal broadcast zone. In some embodiments, the wireless signal broadcast zone may take the form of a WiFi broadcast zone. In such an embodiment, wireless signal positioning systems may be enabled by techniques including, for example: (1) measuring a signal time of flight (from e.g., at least one WiFi transponder to the WiFi-enabled device), (2) measuring an angle of arrival (e.g., of a WiFi signal from a WiFi-enabled device to multiple antennas attached to a WiFi transponder (i.e., MIMO-type WiFi transponder)), (3) fingerprint-type tracking, (4) received-signal strength indication (RSSI), (5) multilateralation, and other means of WiFi tracking. In various embodiments, any means of tracking a wireless device through a space via any wireless signal can be utilized.

The method 500 then proceeds to block 515, where the location of the wireless device is saved or stored. In one embodiment, this location is stored in cloud storage, in association with one or more user apps, and/or in association with commercial entity apps. At block 520, a determination is made as to whether the wireless device remains part of the network. That is, it is determined whether the wireless device is still connected to the WLAN network (e.g., still associated with the store WiFi). If the wireless device remains part of the network, the method 500 returns to block 510. In this manner, as the user moves throughout the wireless signal effective range, the wireless device (which is presumably proximate to the user) is tracked and the position periodically updated, which allows employees to know the location of each user, and thus the identity and preferences of a given user, before they approach. In one embodiment, the period (time) in which this update occurs is chosen such that accuracy of the position of the wireless device is prioritized (e.g., updated using a short interval). In another embodiment, the period (time) in which the update occurs is chosen such that battery drain on the wireless device is minimized (e.g., updated at a longer interval). If the wireless device has been disconnected from the network, the method 500 proceeds to block 525, where the wireless signal transponder optionally saves and/or uploads the final known position of the wireless device after which the method 500 ends.

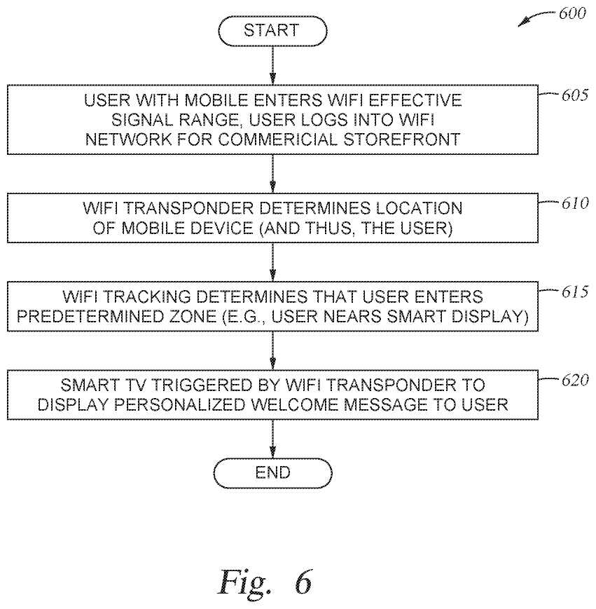

FIG. 6 illustrates a method 600 for triggering smart A/V device(s) to display messages customized to a user, according to one embodiment of the present disclosure. The method 600 begins at block 605, when a user proximate to a wireless device (e.g., carrying the wireless device in a pocket or bag) enters a wireless signal effective range and logs in to a wireless network supplied by a wireless signal transponder. In one embodiment, this wireless signal effective range is a WiFi broadcast zone, and, in one embodiment, the wireless signal transponder is a WiFi transponder or access point. At block 610, at least one wireless signal transponder currently transmitting to the wireless signal transmitter determines the location of the wireless device within the wireless signal broadcast zone. In embodiments, this location determination can involve various tracking techniques discussed herein. In one embodiment, this location determination involves use of a WiFi positioning system. In this manner, the position of the user can be determined or inferred.

The method 600 then proceeds to block 615, where the user (proximate to a wireless device) nears a predetermined or predefined zone, as determined by the wireless signal transponder. In one embodiment, this predetermined zone is a zone associated with one or more A/V devices. For example, in embodiments, this predetermined zone can correspond to a room which contains the A/V device, an effective visual and/or auditory range of the A/V device, and/or any perimeter associated with the A/V device and defined by an administrator or user. In embodiments, the A/V device can be any device as described herein. In some embodiments, the A/V device is connected to the wireless signal transponder (or is connected to the local network via a wired connection). In one embodiment, the A/V device is a smart display capable of displaying messages that are customized to users who are proximate to the A/V device.

At block 620, as the user enters the predetermined zone, the wireless signal transponder triggers the A/V device. In some embodiments, this trigger is performed after the user has entered the zone. In one embodiment, the trigger occurs as the user crosses the threshold into the zone. In another embodiment, the trigger occurs just before the user enters he zone (e.g., as they are approaching it). In one embodiment, the wireless signal transponder triggers the A/V device to play audio or video associated with the user. In one embodiment, the personalized welcome message can be tailored for a repeat customer (e.g., loyalty User A), and display, by way of example, a welcome message of “Welcome Back, User A.” In another embodiment, a first-time customer (e.g., User B) may receive a different message, such as “Hello User B, we are excited about your first visit.”

In one embodiment, the wireless signal transponder and/or the Web2Store Commercial Unit 150 triggers the A/V device to display or output this message to the user. In one embodiment, the wireless signal transponder is a WiFi transponder, the A/V device is a smart TV, and the message is a unique message customized to the user. Further in one embodiment, the contents of the personalized welcome message are associated with pre-boarding login data. For example, in such an embodiment, this unique message can be a personalized welcome message indicating the time of the user's appointment, and/or a suggestion to move to an area of the storefront (e.g., a lobby) and await assistance. In this manner, any A/V device can be triggered to display a message to a user who is now near the A/V device, such that the user is made aware of the message and can follow the message's instructions.

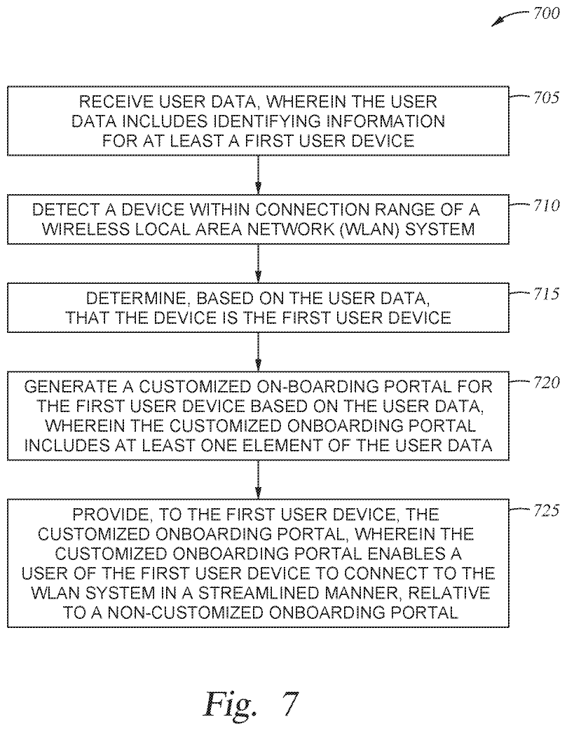

FIG. 7 is a flow diagram illustrating a method for facilitating streamlined WLAN onboarding, according to one embodiment disclosed herein. The method 700 begins at block 705, where the system receives user data, wherein the user data includes identifying information for at least a first user device. At block 710, the system detects a device within connection range of a wireless local area network (WLAN) system. The method 700 then proceeds to block 715, where the system determines, based on the user data, that the device is the first user device. Further, at block 720, the system generates a customized onboarding portal for the first user device based on the user data, wherein the customized onboarding portal includes at least one element of the user data. Finally, the method 700 proceeds to block 725, where the system provides, to the first user device, the customized onboarding portal, wherein the customized onboarding portal enables a user of the first user device to connect to the WLAN system in a streamlined manner, relative to a non-customized onboarding portal.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving user data, wherein the user data includes identifying information for at least a first user device;
detecting a device within connection range of a wireless local area network (WLAN) system;
determining, based on the user data, that the device is the first user device;
generating a customized onboarding portal for the first user device based on the user data, wherein the customized onboarding portal includes at least one element of the user data; and
providing, to the first user device, the customized onboarding portal, wherein the customized onboarding portal enables a user of the first user device to connect to the WLAN system in a streamlined manner, relative to a non-customized onboarding portal.

2. The method of claim 1, the method further comprising:
determining, based on the user data, that the user of the first user device intends to visit a physical location of the WLAN system, wherein the user data is received while the first user device is not in connection range of the WLAN system.

3. The method of claim 1, wherein the user data includes a scheduled appointment at a physical location of the WLAN system, and wherein the customized onboarding portal prompts the user to confirm the scheduled appointment.

4. The method of claim 1, the method further comprising:
upon determining that the device is the first user device, transmitting a notification to an employee device, wherein the notification indicates that the user has entered a physical location of the WLAN system.

5. The method of claim 4, wherein the notification further includes a name of the user and a product that the user has expressed interest in.

6. The method of claim 1, the method further comprising:
allowing the first user device to connect to the WLAN system;
determining a current physical location of the first user device;
identifying one or more output devices proximate to the current physical location of the first user device; and
transmitting, to the identified one or more output devices, at least one element of the user data.

7. The method of claim 6, wherein transmitting, to the identified one or more output devices, at least one element of the user data comprises:
transmitting a name of the user to the identified one or more output devices; and
transmitting an instruction for the user to the identified one or more output devices, wherein the identified one or more output devices, upon receiving the transmission, output the name of the user and the instruction for the user.

8. A computer-readable storage medium having non-transitory computer-readable program code embodied therewith, the computer-readable program code executable by one or more computer processors to perform an operation comprising:
receiving user data, wherein the user data includes identifying information for at least a first user device;
detecting a device within connection range of a wireless local area network (WLAN) system;
determining, based on the user data, that the device is the first user device;
generating a customized onboarding portal for the first user device based on the user data, wherein the customized onboarding portal includes at least one element of the user data; and
providing, to the first user device, the customized onboarding portal, wherein the customized onboarding portal enables a user of the first user device to connect to the WLAN system in a streamlined manner, relative to a non-customized onboarding portal.

9. The computer-readable storage medium of claim 8, the operation further comprising:
determining, based on the user data, that the user of the first user device intends to visit a physical location of the WLAN system, wherein the user data is received while the first user device is not in connection range of the WLAN system.

10. The computer-readable storage medium of claim 8, wherein the user data includes a scheduled appointment at a physical location of the WLAN system, and wherein the customized onboarding portal prompts the user to confirm the scheduled appointment.

11. The computer-readable storage medium of claim 8, the operation further comprising:
upon determining that the device is the first user device, transmitting a notification to an employee device, wherein the notification indicates that the user has entered a physical location of the WLAN system.

12. The computer-readable storage medium of claim 11, wherein the notification further includes a name of the user and a product that the user has expressed interest in.

13. The computer-readable storage medium of claim 8, the operation further comprising:
allowing the first user device to connect to the WLAN system;
determining a current physical location of the first user device;
identifying one or more output devices proximate to the current physical location of the first user device; and
transmitting, to the identified one or more output devices, at least one element of the user data.

14. The computer-readable storage medium of claim 13, wherein transmitting, to the identified one or more output devices, at least one element of the user data comprises:
transmitting a name of the user to the identified one or more output devices; and
transmitting an instruction for the user to the identified one or more output devices, wherein the identified one or more output devices, upon receiving the transmission, output the name of the user and the instruction for the user.

15. A system comprising:
one or more computer processors; and
a memory containing a program which when executed by the one or more computer processors performs an operation, the operation comprising:
receiving user data, wherein the user data includes identifying information for at least a first user device;
detecting a device within connection range of a wireless local area network (WLAN) system;
determining, based on the user data, that the device is the first user device;
generating a customized onboarding portal for the first user device based on the user data, wherein the customized onboarding portal includes at least one element of the user data; and
providing, to the first user device, the customized onboarding portal, wherein the customized onboarding portal enables a user of the first user device to connect to the WLAN system in a streamlined manner, relative to a non-customized onboarding portal.

16. The system of claim 15, the operation further comprising:
determining, based on the user data, that the user of the first user device intends to visit a physical location of the WLAN system, wherein the user data is received while the first user device is not in connection range of the WLAN system.

17. The system of claim 15, wherein the user data includes a scheduled appointment at a physical location of the WLAN system, and wherein the customized onboarding portal prompts the user to confirm the scheduled appointment.

18. The system of claim 15, the operation further comprising:
upon determining that the device is the first user device, transmitting a notification to an employee device, wherein the notification indicates that the user has entered a physical location of the WLAN system, and wherein the notification includes a name of the user and a product that the user has expressed interest in.

19. The system of claim 15, the operation further comprising:
allowing the first user device to connect to the WLAN system;
determining a current physical location of the first user device;
identifying one or more output devices proximate to the current physical location of the first user device; and
transmitting, to the identified one or more output devices, at least one element of the user data.

20. The system of claim 19, wherein transmitting, to the identified one or more output devices, at least one element of the user data comprises:
transmitting a name of the user to the identified one or more output devices; and
transmitting an instruction for the user to the identified one or more output devices, wherein the identified one or more output devices, upon receiving the transmission, output the name of the user and the instruction for the user.
